(19) United States
(12) Patent Application Publication
(10) Pub. No.: US 2008/0238317 A1
(43) Pub. Date: Oct. 2, 2008

(54) OPTICAL SHEET FOR PLASMA DISPLAY PANEL AND METHOD FOR MANUFACTURING THE SAME

(76) Inventors: Hyouk KWON, Seoul (KR); Young Joo Yee, Seongnam-si (KR); Chi Hwan Jeong, Seoul (KR)

Correspondence Address: KED & ASSOCIATES, LLP, P.O. Box 221200, Chantilly, VA, 20153-1200, US

(21) Appl. No.: 12/053,024

(22) Filed: Mar. 21, 2008

(30) Foreign Application Priority Data
Mar. 26, 2007 (KR) 10-2007-0029146

(51) Int. Cl. H01J 17/49; H01J 61/40; B29D 7/01

(52) U.S. Cl. 313/582; 313/113; 264/1.34

(57) ABSTRACT

Disclosed are an optical sheet for a plasma display panel, a method for manufacturing the same and a plasma display panel employing the same. More particularly, provided are an optical sheet for a plasma display panel to improve a contrast ratio and a method for manufacturing the same. The optical sheet for a plasma display panel comprises a transparent substrate, a plurality of light-transmitting structures arranged on the transparent substrate, a reflective film arranged on the side of each of the light-transmitting structures, a black matrix arranged on the reflective film, and a cover part arranged on the black matrix.

This application claims the benefit of Korean Patent Application No. 10-2007-0029146, filed on Mar. 26, 2007, which is hereby incorporated by reference as if fully set forth herein.

### BACKGROUND OF THE INVENTION

1. Field of the Invention

The present invention relates to an optical sheet for a plasma display panel, a method for manufacturing the optical sheet and a plasma display panel employing the same. More particularly, the present invention relates to an optical sheet for a plasma display panel to improve a contrast ratio and a method for manufacturing the same.

2. Discussion of the Related Art

In response to the demand for large-screen, high-quality flat panels, a variety of displays are being provided, which satisfy the requirements of high quality and large screen. In particular, plasma display panels (hereinafter, referred to as “PDPs”) employing a plasma technique have been increasingly developed.

PDPs include a panel part and a front filter made of a glass or plastic. Light is emitted from image display units, so-called pixels, in the panel, and then undergoes optical compensation and electromagnetic shielding in the optical filter, thereby displaying image.

Bright room contrast of PDPs is determined by a black matrix and a filter arranged between pixels in the panel via random emission of scattered light. Because of limitations of the black matrix, further improvement in bright room contrast of PDPs is necessary to compete with other large-screen flat panel displays such as direct-view LCDs and rear projection displays.

### SUMMARY OF THE INVENTION

Accordingly, the present invention is directed to a plasma display panel and a method for manufacturing the same that substantially obviate one or more problems due to limitations and disadvantages of the related art.

An object of the present invention is to provide an optical sheet for a plasma display panel and a method for manufacturing the same wherein an area ratio of black matrix to screen is increased to promote external light absorption by the black matrix, loss of light emitted from respective pixels in the panel is reduced to improve bright room contrast, thereby improving the quality of images displayed by the plasma display panel, and the optical sheet can shield electromagnetic radiation without any additional filter in order to reduce a thickness of the plasma display panel, thereby reducing manufacturing costs.

Additional advantages, objects, and features of the invention will be set forth in part in the description which follows and in part will become apparent to those having ordinary skill in the art upon examination of the following or may be learned from practice of the invention. The objectives and other advantages of the invention may be realized and attained by the structure particularly pointed out in the written description and claims hereof as well as the appended drawings.

To achieve these objects and other advantages and in accordance with the purpose of the invention, as embodied and broadly described herein, an optical sheet for a plasma display panel comprises: a transparent substrate; a plurality of light-transmitting structures arranged on the transparent substrate; a reflective film arranged on the side of each of the light-transmitting structures; a black matrix arranged on the reflective film; and a cover part arranged on the black matrix.

In another aspect of the present invention, an optical sheet for a plasma display panel comprises: a transparent substrate; a plurality of light-transmitting structures in the shape of stripes or a matrix arranged on the transparent substrate in each discharge cell of the plasma display panel; a reflective film arranged on the side of each of the light-transmitting structures; a black matrix arranged on the reflective film; and a cover part arranged on the black matrix.

In another aspect of the present invention, a method for manufacturing an optical sheet for a plasma display panel comprises: forming a plurality of light-transmitting structures on a transparent substrate; forming a reflective film on the side of each of the light-transmitting structures; forming a black matrix on the reflective film; and forming a cover part on the black matrix.

It is to be understood that both the foregoing general description and the following detailed description of the present invention are exemplary and explanatory and are intended to provide further explanation of the invention as claimed.

### BRIEF DESCRIPTION OF THE DRAWINGS

The accompanying drawings, which are included to provide a further understanding of the invention and are incorporated in and constitute a part of this application, illustrate embodiment(s) of the invention and together with the description serve to explain the principle of the invention. In the drawings:

FIG. 1 is a schematic perspective view illustrating an optical film of a plasma display panel (PDP) according to a first embodiment of the present invention;

FIG. 2 is a schematic cross-sectional view illustrating an optical film of a PDP;

FIGS. 3a and 3c are perspective and cross-sectional views illustrating the structure of an optical sheet for a PDP according to a second embodiment of the present invention, respectively;

FIG. 4 shows another example of the cover part according to the second embodiment of the present invention;

FIGS. 5a to 5d are views illustrating an optical filler to improve the contrast of the PDP according to a third embodiment of the present;

FIG. 6 is a view illustrating a fourth embodiment of the present invention;

FIGS. 7a to 7d are cross-sectional views illustrating a method for manufacturing the optical sheet for a PDP according to the second embodiment, as a fourth embodiment of the present invention; and

FIG. 8 is a conceptual diagram illustrating improvement in bright room contrast ratio of an optical sheet of a PDP according to the present invention.

### DETAILED DESCRIPTION OF THE INVENTION

Reference will now be made in detail to the preferred embodiments of the present invention, examples of which are illustrated in the accompanying drawings.

The present invention may, however, be embodied in many alternate forms and should not be construed as limited to the embodiments set forth herein. Accordingly, while the invention is susceptible to various modifications and alternative forms, specific embodiments thereof are shown by way of example in the drawings and will herein be described in detail. It should be understood, however, that there is no intent to limit the invention to the particular forms disclosed, but on the contrary, the invention is to cover all modifications, equivalents, and alternatives falling within the spirit and scope of the invention as defined by the claims.

It will be understood that when an element such as a layer, region or substrate is referred to as being “on” another element, it can be directly on the other element or intervening elements may also be present. It will also be understood that if part of an element, such as a surface, is referred to as “inner” it is farther from the outside of the device than other parts of the element.

It will be understood that, although the terms first, second, etc. may be used herein to describe various elements, components, regions, layers and/or sections, these elements, components, regions, layers and/or sections should not be limited by these terms.

These terms are only used to distinguish one region, layer or section from another region, layer or section. Thus, a first region, layer or section discussed below could be termed a second region, layer or section, and similarly, a second region, layer or section may be termed a first region, layer or section without departing from the teachings of the present invention.

### FIRST EMBODIMENT

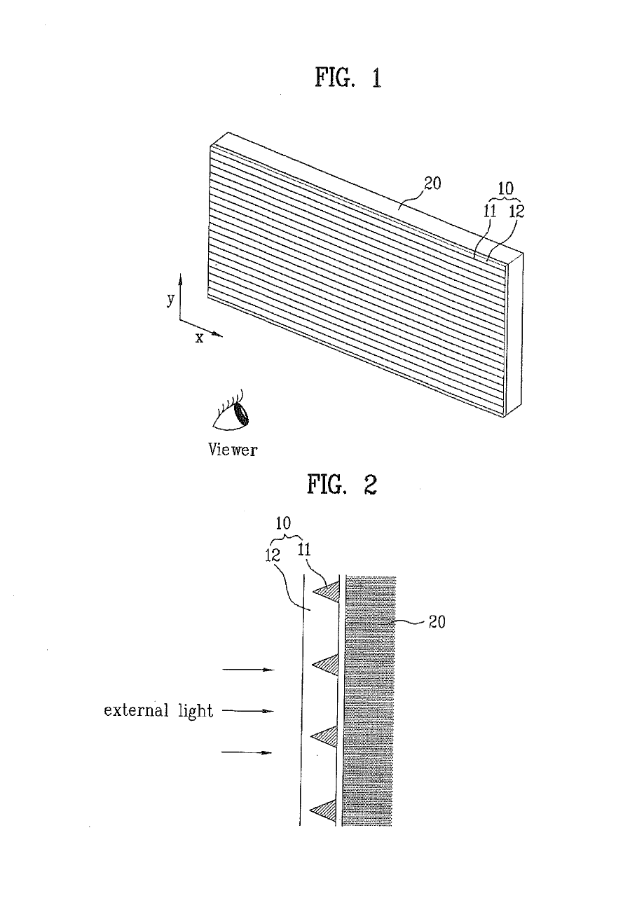

FIG. 1 is a schematic perspective view illustrating an optical film of a plasma display panel (PDP) according to a first embodiment of the present invention. As shown in FIG. 1, an optical film 10 is arranged on the front side of a plasma display panel 20 and includes a plurality of black stripe bars 11 repeatedly arranged in a horizontal direction and a transparent material 12 covering all surfaces of each black stripe bar 11 except the bottom.

Since the optical film 10 for improvement of a contrast ratio of the plasma display panel 20 includes the horizontally arranged black stripe bars 11, it can prevent reflection of only external light irradiated perpendicularly to the surface of the screen of the plasma display panel 20.

That is to say, in the case of external incident light entering from the left or right of the screen, the optical film 10 cannot improve the contrast ratio.

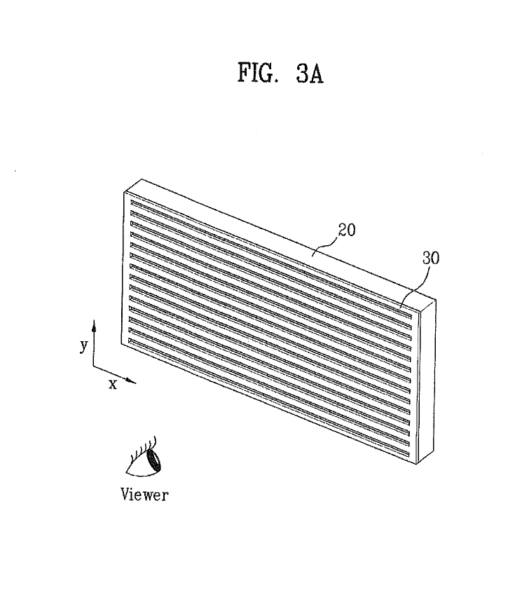

FIG. 2 is a schematic cross-sectional view illustrating an optical film of a plasma display panel (PDP). The optical film 10 for improvement of contrast ratio is arranged on the surface of the screen of the plasma display panel 20.

In the optical film 10, the black stripe bar 11 and the transparent material 12 are a light-blocking part and a light-transmitting part, respectively. In the case of conventional optical films to improve a contrast ratio, the black stripe bar 11 absorbs external light. However, light emitted from a plasma display panel is often absorbed by the bottom and sides of the black stripe bar 11, undesirably causing deterioration in brightness. In addition, such an optical film further requires a separate electromagnetic radiation-shielding film.

### SECOND EMBODIMENT

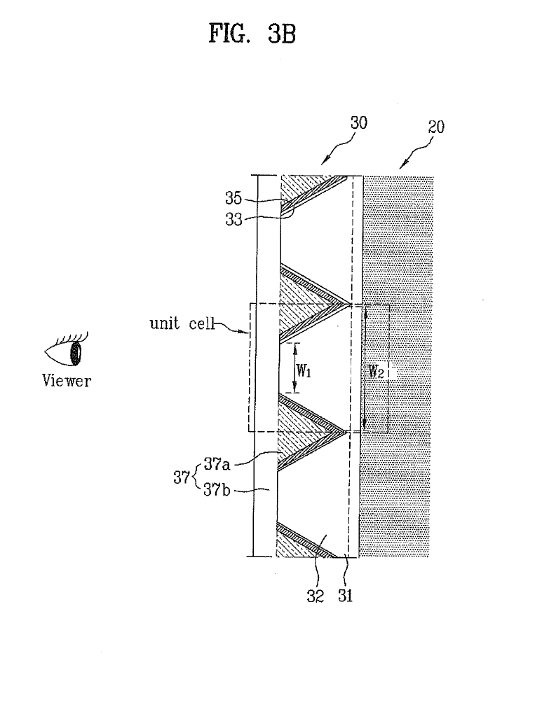

FIGS. 3a and 3c are perspective and cross-sectional views, respectively, illustrating the structure of an optical sheet for a plasma display panel (PDP) according to a second embodiment of the present invention.

As shown in FIG. 3a, an optical sheet 30, which blocks external incident light and radiates light emitted from the panel to the outside, is arranged on the front substrate of the plasma display panel 20.

FIG. 3b is a cross-sectional view taken along the vertical direction (y axis direction) in FIG. 3a. Referring to FIG. 3b, the optical sheet 30 includes unit cells, each of which includes a transparent substrate 31, a plurality of light-transmitting structures 32, a reflective film 33, a black matrix 35 and a cover part 37.

The transparent substrate 31 is arranged on the front substrate of the plasma display panel 20 to increase the contrast ratio. Further, other constituent component (e.g. a filter) to perform separate functions may be interposed between the plasma display panel 20 and the transparent substrate 31.

The light-transmitting structures 32 are arranged on the transparent substrate 31, which has a top width W1 and a bottom width W2 wherein the top width W1 is smaller than the bottom width W2. The bottoms of the light-transmitting structures 32 are adjacent to each other. The term “top of the light-transmitting structure 32” refers to a side upon which external light is incident. The term “bottom of the light-transmitting structure 32” refers to a side upon which light emitted from the plasma display panel is incident.

The optical filter shown in FIG. 2 shows decreased light output in a lower part where the black matrix is arranged. On the other hand, according to the present embodiment, the light-transmitting structures of the optical sheet are designed to allow the top width W1 to be smaller than the bottom width W2 and to contact the bottoms of light-transmitting structures each other. Accordingly, light emitted from the plasma display panel radiates though at least one unit cell to the outside, thus exhibiting an increased output amount.

The light-transmitting structure 32 and the transparent substrate 31 may be composed of identical or different materials. The light-transmitting structure 32 may be integrally formed with the transparent substrate 31.

The reflective film 33 is arranged on the side of the light-transmitting structure 32. The reflective film 33 may be made of a material including silver (Ag) or/and aluminum (Al) and reflects light emitted from the plasma display panel to the outside.

The black matrix 35 is arranged in the form of a stripe on the reflective film 33 and absorbs external incident light. The black matrix is made of blackened metal (e.g. copper (Cu)). The black matrix 35 absorbs external incident light and is made of metal so as to shield electromagnetic radiation emitted from the plasma display panel.

Preferably, the black matrix 35 is formed on the reflective film 33 on the light-transmitting structure 32 to a uniform thickness. The black matrix of one unit cell is combined with that of the adjacent unit cell to form a V-shape, thereby absorbing external incident light.

The cover part 37 fills the spaces defined by the black matrixes 35 and is arranged on the black matrix 35 and the light-transmitting structure 32 to protect the black matrix 35 and the light-transmitting structure 32. The cover part 37 includes a filling part 37a to fill the V-shape valley defined by the adjacent two black matrixes and a cover film 37b to cover the top of the light-transmitting structure.

The optical film according to the present embodiment as constituted above allows external incident light to pass though the cover part 37 and be mostly then absorbed by the black matrix 35. In addition, light emitted from the plasma display panel radiates directly, or is reflected by the reflective film and then radiates through the top of the light-transmitting structure (32) to the outside.

FIG. 3c is a plane view of the present embodiment.

A region where the black matrix 35 is formed appears dark. Only the top of the light-transmitting structure 32 is exposed to the outside in the form of a stripe. Based on the light-transmitting structure 32, it is possible to realize radiation almost all internal light to the outside while blocking only an extremely small quantity.

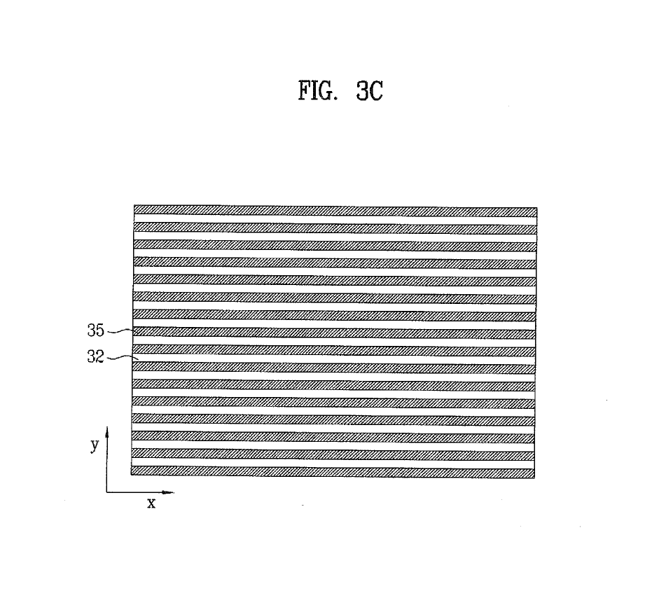

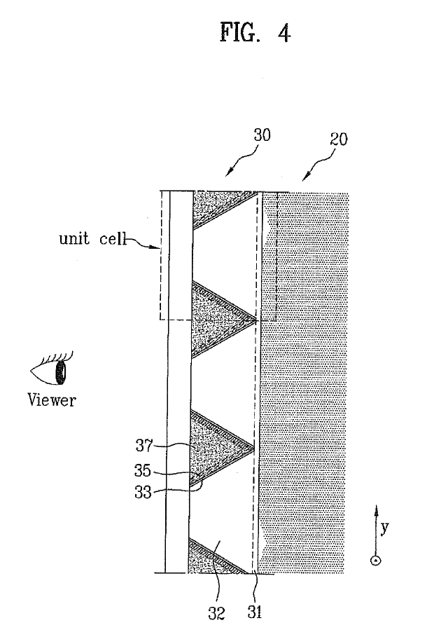

Referring to the cover part 37, as shown in FIG. 3a, the filling part 37a is made of a transparent material. Alternatively, as shown in FIG. 4, the filling part 37a is made of an opaque material including black polymers or carbon black, ink and the like.

### THIRD EMBODIMENT

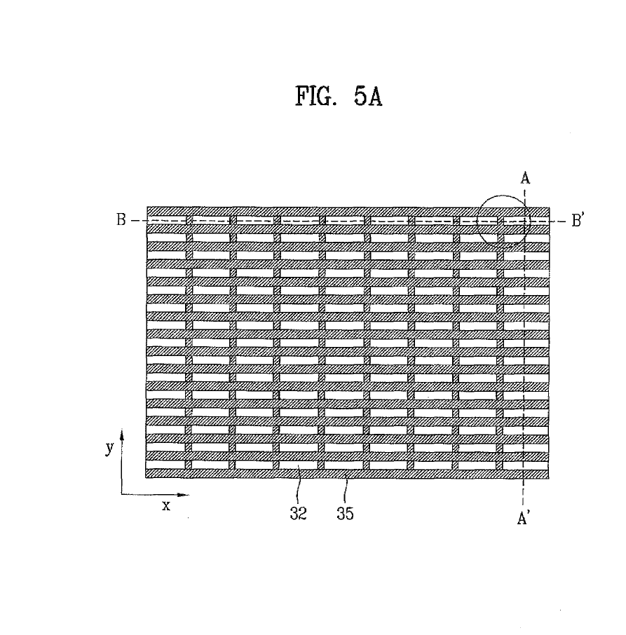

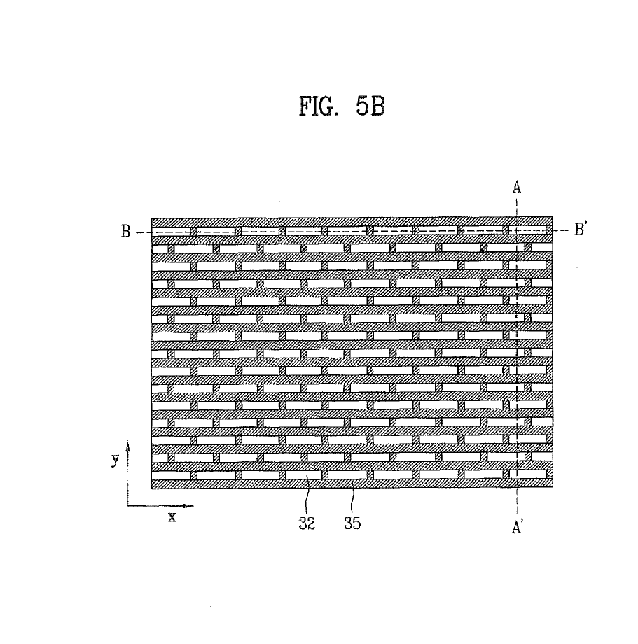

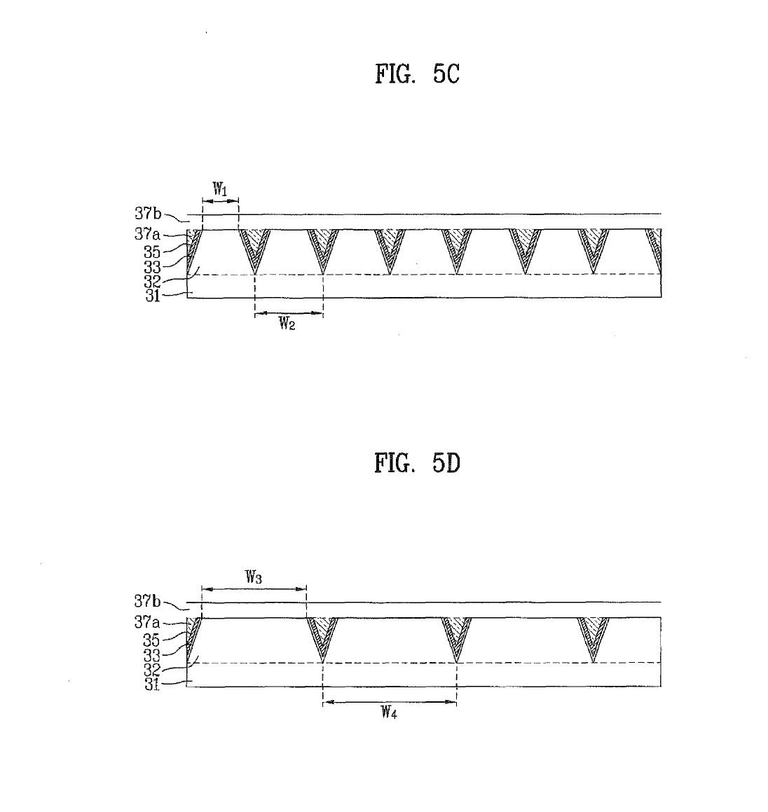

FIGS. 5a to 5d illustrate an optical filler to improve the contrast of the PDP according to a third embodiment of the present. FIGS. 5a and 5b are plane views illustrating the optical filter. FIGS. 5c and 5d are cross-sectional views taken along the lines A-A′ and B-B′ in FIGS. 5a and 5b, respectively.

FIGS. 5a to 5d show a two-dimensional structure of the black matrix according to the present embodiment. According to the present embodiment, the light-transmitting structures 32 are in the form of a short stripe, unlike the form of a long stripe shown in FIG. 3a, and are surrounded by the black matrix 35. In addition, the light-transmitting structures 32 are arranged along x and y axes, as shown in FIG. 5a. Alternatively, the light-transmitting structures 32 may be arranged to be uniformly inclined to the y axis, as shown in FIG. 5b.

The optical film for improvement of the contrast ratio of the plasma display panel includes a transparent substrate 31 and a plurality of light-transmitting structures 32 disposed on the transparent substrate 31, as shown in FIGS. 5c and 5d. The top width W1/W3 of each light-transmitting structure 32 is smaller than a bottom width W2/W4 thereof. The bottoms of the adjacent two light-transmitting structures 32 are adjacent to each other. At this time, the widths W3 and W4 of the light-transmitting structure in an x-axis direction are larger than the widths W1 and W2 of the light-transmitting structure in a y-axis direction.

The light-transmitting structure 32 and the transparent substrate 31 may be composed of identical or different materials. The light-transmitting structure 32 may be integrally formed with the transparent substrate 31.

The reflective film 33 is arranged on the side of the light-transmitting structure 32. The reflective film 33 may be made of a material including silver (Ag) or/and aluminum (Al) and reflects light emitted from the plasma display panel to the outside.

The black matrix 35 is in the form of a stripe on the reflective film 33, which absorbs external incident light. The black matrix is made of blackened metal (e.g. copper (Cu)). The black matrix 35 absorbs external incident light and is made of metal so as to shield electromagnetic radiation emitted from the plasma display panel.

Preferably, the black matrix 35 is formed to a uniform thickness on the reflective film 33 on the light-transmitting structure 32. The black matrixes of the adjacent two unit cells are combined with each other to form a V-shape, thereby absorbing external light.

The cover part 37 fills the space defined by the black matrix 35 and is arranged on the black matrix 35 and the light-transmitting structure 32 to protect the black matrix 35 and the light-transmitting structure 32. The cover part 37 includes a filler 37a to fill the space between the black matrix 35 and a cover material 37b to cover the top of the cover part 37 and the light-transmitting structure 32.

### FOURTH EMBODIMENT

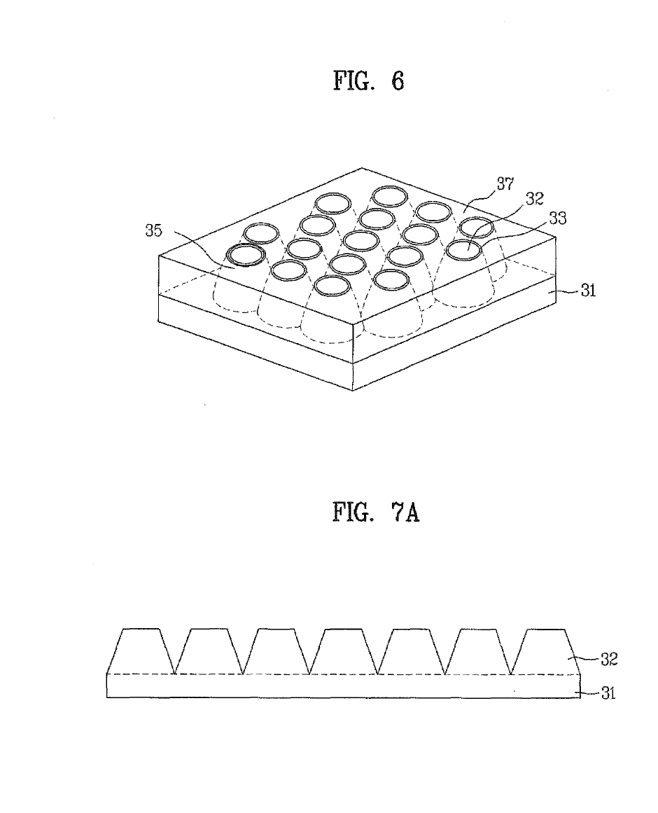

FIG. 6 is a view illustrating a fourth embodiment of the present invention. According to the present embodiment shown in FIGS. 5a and 5b, a plurality of light-transmitting structures 32 are arranged in the shape of a truncated cone on the transparent substrate. Except for the shape of the light-transmitting structure 32, the present embodiment is the same as the aforementioned embodiment shown in FIGS. 5c and 5d. Thus, a more detailed explanation thereof will be omitted.

### FIFTH EMBODIMENT

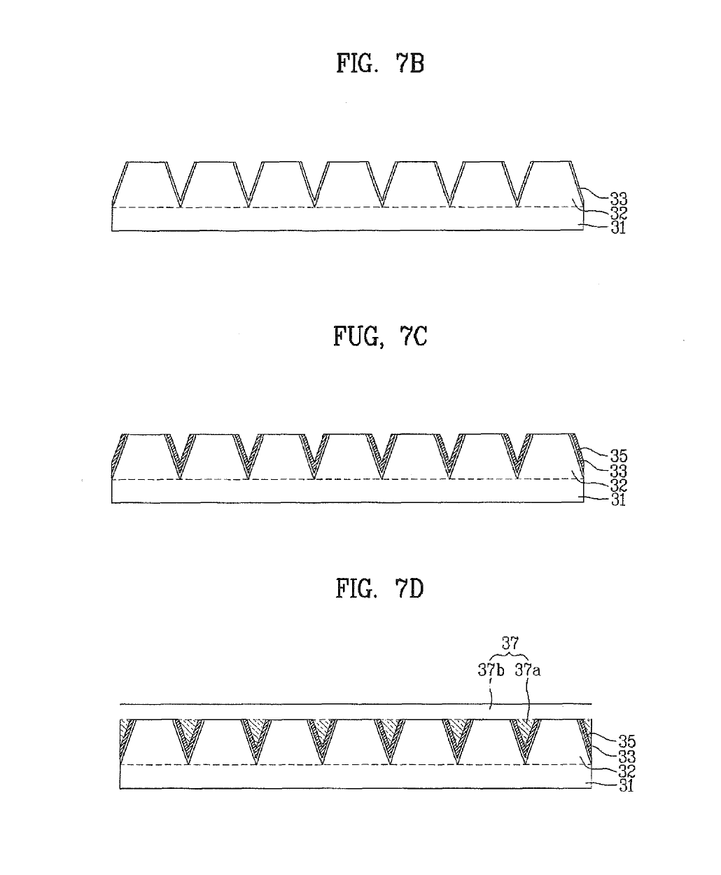

FIGS. 7a to 7d are cross-sectional views illustrating a method for manufacturing the optical sheet for a plasma display panel according to the aforementioned second embodiment.

First, as shown in FIG. 7a, a plurality of light-transmitting structures 32 having a top width smaller than a bottom width thereof are formed on the transparent substrate 31. The formation of the light-transmitting structure 32 is carried out by depositing the light-transmitting structure 32 on the transparent substrate 31. The deposition may be performed by printing, dry film methods, and the like.

Alternatively, the light-transmitting structure 32 may be formed by etching the transparent substrate 31. More specifically, a V-shape valley may be formed on a thick transparent substrate 31 by etching, photolithography or sandblasting.

Then, as shown in FIG. 7b, a reflective film 33 is formed on the side of the light-transmitting structure 32. The formation of the reflective film 33 is carried out by depositing or coating silver (Ag) or aluminum (Al) on the light-transmitting structure 32.

Then, as shown in FIG. 7c, a black matrix 35 is formed on the reflective film 33. The formation of the black matrix 35 is carried out by depositing or coating a conductive thin film on the reflective film and blackening the metallic thin film.

Then, as shown in FIG. 7d, a cover part 37 is formed on the black matrix 35 and the light-transmitting structure such that the cover part 37 fills the space between the black matrixes. The cover part 37 includes a filler 37a to fill the space between the black matrixes 35 and a cover material 37b to cover the top of the cover part 37 and the light-transmitting structure 32. The filler 37a and cover material 37b may be composed of identical or different materials. The filler 37a is formed of an opaque material and the cover material 37b is formed of a transparent material.

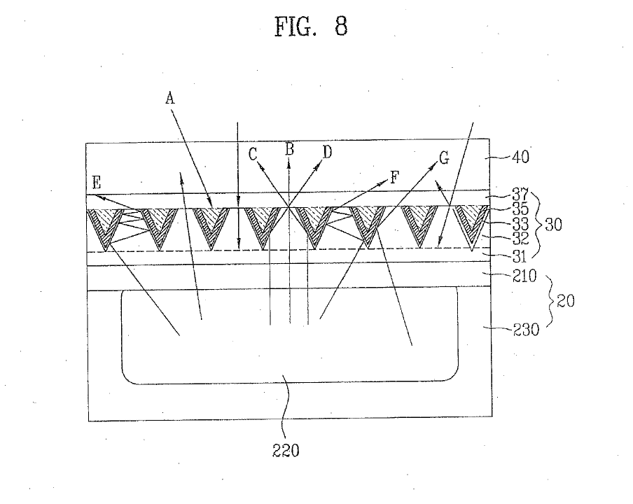

FIG. 8 is a conceptual diagram illustrating improvement in bright room contrast ratio of an optical sheet of a plasma display panel according to the present invention.

First, an optical sheet 30 is arranged on an upper substrate 210 of the plasma display panel 20. Another filter 30 may be arranged on the black matrix 35 of the optical filter 30. That is to say, the plasma display panel includes a lower substrate, where a barrier rib 230 surrounds a plurality of pixels, and an upper substrate 210 arranged above the pixels.

In FIG. 8, the optical sheet is hypothetically enlarged and a reduced scale of the optical sheet is the same as that of the plasma display panel.

Herein, another filter 40 may be any one of an anti-reflective film, an electromagnetic interference (EMI) shielding film and a near infrared (NIR) shielding film.

That is to say, the anti-reflective film prevents light emitted from the plasma display panel from being reflected into the plasma display panel to increase emission of light to the outside.

Thus, the optical sheet according to the present invention is arranged on the front side of the plasma display panel and thus allows the black matrix to block external light incident perpendicularly and horizontality to the optical sheet to prevent deterioration in contrast ratio of the plasma display panel.

Image light produced from the plasma display panel is emitted through the light-transmitting structure 32 surrounded by the black matrix 35 to the outside.

As mentioned above, since the bottom width of the light-transmitting structure 32 toward the plasma display panel is larger than the top width thereof, an amount of image light emitted from the plasma display panel to the outside is high and external incident light is low.

In addition, the reflective film 33 is arranged under the black matrix 35, which reflects image light generated from the plasma display panel to increase an amount of image light emitted to the outside.

That is to say, as shown in FIG. 8, image light is emitted from the pixel 220 surrounded by the barrier rib 230 in the plasma display panel to the outside through holes surrounded by the black matrix 35 and the filter 40.

Preferably, a plurality of through holes corresponds to the pixel region of the plasma display panel.

At this time, light ray B, out of contact with the reflective film 33, passes through the through hole. Light rays C, D, E, F, and G, in contact with the reflective film 33, are reflected by the reflective film 33 and then pass through the through hole.

Accordingly, the optical sheet of the present invention enables an increase in output image light via the light-transmitting structure 32 in the shape of an inverted triangle pointed towards the plasma display panel. In addition, the optical sheet is capable of increasing external light (light A) absorption efficiency owing to a large area of the black matrix 35.

The black matrix 35 is formed of any one of a black resin, carbon black, a conductive black polymer and a blackened metal. In addition, the reflective film 33 is formed of a metal with high reflectivity and low conductivity.

As such, the black matrix composed of a conductive material such as carbon black, a conductive black polymer or a blacked metal and the reflective film composed of a metal can perform additional functions i.e., shielding of electromagnetic radiation generated by the plasma display panel. That is, the black matrix and the reflective film are capable of replacing a metal mesh for preventing electromagnetic interference (EMI) in conventional plasma display panels.

Accordingly, the optical sheet according to the present invention provides optical effects e.g. improvement in contrast ratio and electric effects e.g. electromagnetic interference (EMI) shielding, thus being highly economically efficient owing to reduced manufacturing costs thereof.

As apparent from the foregoing, according to the present invention, it is possible to promote external light absorption of the black matrix via an increase in an area ratio of black matrix to screen and to improve bright room contrast via a reduction in loss of light emitted from respective pixels in the panel.

As a result, a plasma display panel can be provided, which has improved image quality and is capable of shielding electromagnetic radiation without any additional filter. Furthermore, it is possible to reduce a thickness of the plasma display panel and realize reduced manufacturing costs.

It will be apparent to those skilled in the art that various modifications and variations can be made in the present invention without departing from the spirit or scope of the inventions. Thus, it is intended that the present invention covers the modifications and variations of this invention provided they come within the scope of the appended claims and their equivalents.

What is claimed is:

1. An optical sheet for a plasma display panel comprising:
a transparent substrate;
a plurality of light-transmitting structures arranged on the transparent substrate;
a reflective film arranged on the side of each of the light-transmitting structures;
a black matrix arranged on the reflective film; and
a cover part arranged on the black matrix.

2. The optical sheet for a plasma display panel according to claim 1, wherein the black matrix is formed to a uniform thickness on the reflective film.

3. The optical sheet for a plasma display panel according to claim 1, wherein the black matrix is made of a conductive black metal.

4. The optical sheet for a plasma display panel according to claim 3, wherein the black matrix includes copper (Cu).

5. The optical sheet for a plasma display panel according to claim 1, wherein the reflective film is made of silver (Ag) or aluminum (Al).

6. The optical sheet for a plasma display panel according to claim 3, wherein the cover part includes a filling part to fill the space between the adjacent black matrixes and a cover film to cover the top of the light-transmitting structure.

7. The optical sheet for a plasma display panel according to claim 6, wherein the filling part is made of an opaque material.

8. The optical sheet for a plasma display panel according to claim 7, wherein the opaque material includes at least one of a black polymer, carbon black and ink.

9. The optical sheet for a plasma display panel according to claim 1, wherein the light-transmitting structures are arranged in the form of stripes or a matrix on the transparent substrate.

10. The optical sheet for a plasma display panel according to claim 1, wherein each of the light-transmitting structures is arranged in each discharge cell of the plasma display panel.

11. The optical sheet for a plasma display panel according to claim 1, wherein the light-transmitting structures take the shape of a truncated cone.

12. The optical sheet for a plasma display panel according to claim 1, wherein the light-transmitting structures have a bottom width in contact with the substrate and a top width out of contact with the substrate, wherein the bottom width is larger than the top width.

13. The optical sheet for a plasma display panel according to claim 1, wherein the light-transmitting structures are arranged such that the light-transmitting structures externally contact each other through a side in contact with the transparent substrate.

14. An optical sheet for a plasma display panel comprising:
a transparent substrate;
a plurality of light-transmitting structures in the shape of stripes or a matrix arranged on the transparent substrate in each discharge cell of the plasma display panel;
a reflective film arranged on the side of each of the light-transmitting structures;
a black matrix arranged on the reflective film; and
a cover part arranged on the black matrix.

15. The optical sheet for a plasma display panel according to claim 14, wherein the cover part includes a filling part to fill the space between the adjacent black matrixes and a cover film to cover the top of the light-transmitting structure.

16. The optical sheet for a plasma display panel according to claim 14, wherein the black matrix is formed of a conductive black metal.

17. The optical sheet for a plasma display panel according to claim 16, wherein the black matrix serves as an electromagnetic radiation-shielding layer.

18. A method for manufacturing an optical sheet for a plasma display panel comprising:
forming a plurality of light-transmitting structures on a transparent substrate;
forming a reflective film on the side of each of the light-transmitting structures;
forming a black matrix on the reflective film; and
forming a cover part on the black matrix.

19. The method according to claim 18, wherein the step of forming the light-transmitting structure is carried out by depositing the light-transmitting structure on the transparent substrate.

20. The method according to claim 18, wherein the step of forming the light-transmitting structures is carried out by etching the transparent substrate.

21. The method according to claim 18, wherein the step of forming the reflective film is carried out by depositing or coating silver (Ag) or aluminum (Al) on the light-transmitting structure.

22. The method according to claim 18, wherein the step of forming the black matrix includes depositing or coating a conductive thin film on the reflective film and blacking the resulting metal thin film.

23. A plasma display panel comprising,
an optical sheet arranged on the front side of the plasma display panel, including:
a transparent substrate;
a plurality of light-transmitting structures arranged on the transparent substrate;
a reflective film arranged on the side of each of the light-transmitting structures;
a black matrix arranged on the reflective film; and
a cover part arranged on the black matrix.
